(19) United States
(12) Patent Application Publication
(10) Pub. No.: US 2010/0138782 A1
(43) Pub. Date: Jun. 3, 2010

(54) ITEM AND VIEW SPECIFIC OPTIONS

(75) Inventor: Roope Rainisto, Helsinki (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/325,213

(22) Filed: Nov. 30, 2008

(51) Int. Cl. G06F 3/048

(52) U.S. Cl. 715/808; 715/841; 715/823

(57) ABSTRACT

A method that includes detecting an activation of a selectable item, determining if the activation is one of a first type or a second type, and if the activation is of the first type, presenting a list of application specific options associated with an application view corresponding to the selectable item, and if the activation is of the second type, presenting a list of item specific options associated with the selected item.

### CROSS-REFERENCE TO RELATED APPLICATIONS

This application is related to U.S. patent application Ser. No. ______, filed on 30 Nov. 2008, (Atty Docket No. 684-013660-US(PAR), Disclosure No. NC66441) entitled “Phonebook Arrangement”, the disclosure of which is incorporated herein by reference in its entirety.

### BACKGROUND

1. Field

The aspects of the disclosed embodiments generally relate to user interfaces and more particularly to a user interface for accessing option and function menus.

2. Brief Description of Related Developments

Generally, to access an options menu related to an application or application view, one has to access a toolbar that includes the desired functions or commands. For example, when in a phonebook or contacts application, to create a new contact, one has to activate the toolbar menu item related to that desired function. In many cases, unless one is quite familiar with the options under each of the different toolbar headings, one may have to search for the desired function, operation or service. If the toolbar does not happen to be displayed, it may be necessary to drill down various menu hierarchies to find the desired function, operation or service.

It would be advantageous to be able to easily and intuitively find and access functions that operate on an application or a specific view associated with an application.

### SUMMARY

The aspects of the disclosed embodiments are directed to at least a method, apparatus, user interface and computer program product. In one embodiment the method includes detecting an activation of a selectable item, determining if the activation is one of a first type or a second type, and if the activation is of the first type, presenting a list of application specific options associated with an application view corresponding to the selectable item, and if the activation is of the second type, presenting a list of item specific options associated with the selected item.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A-2E illustrate exemplary user interfaces incorporating aspects of the disclosed embodiments;

FIG. 3 is illustrates an exemplary process including aspects of the disclosed embodiments;

FIGS. 4A and 4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(s)

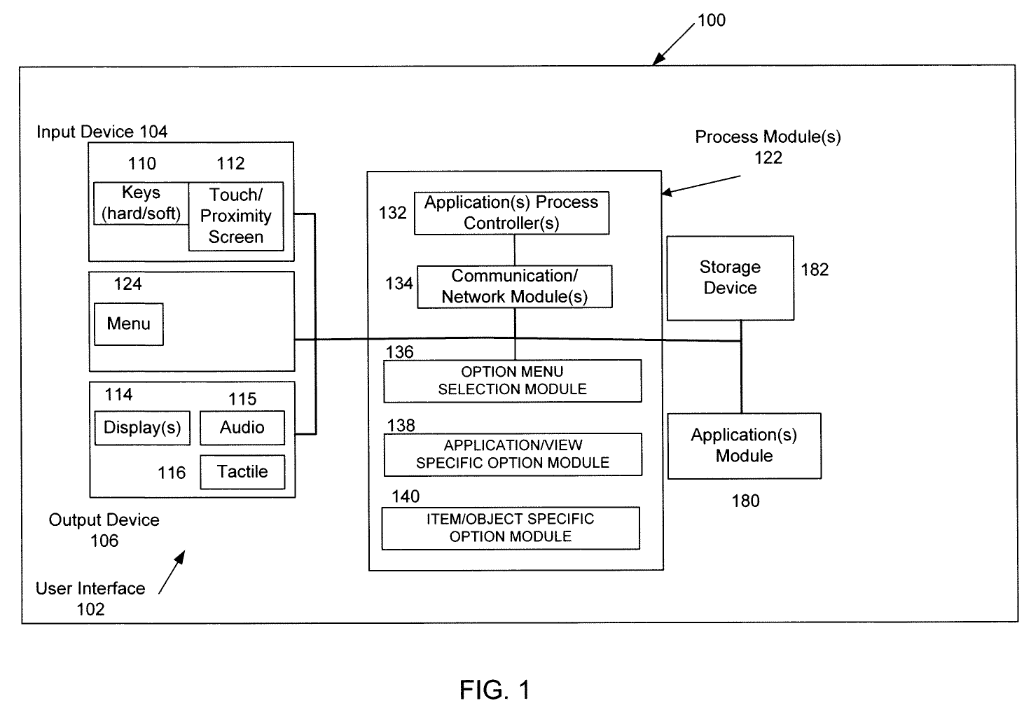

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

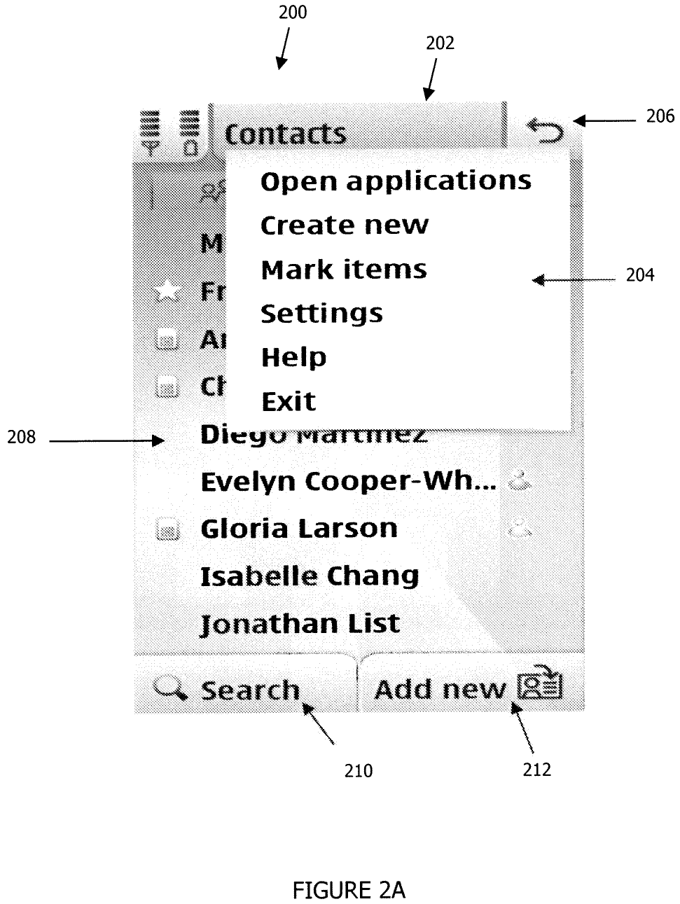

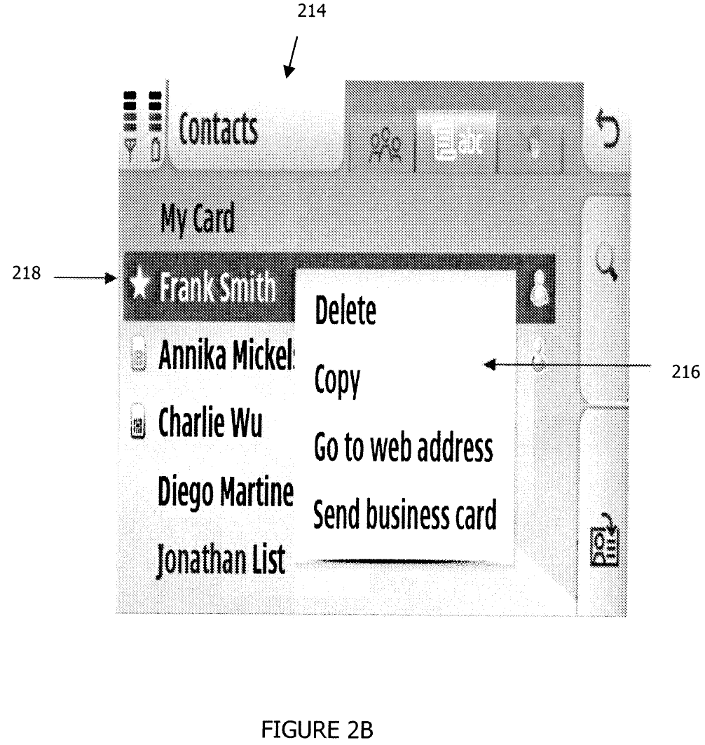

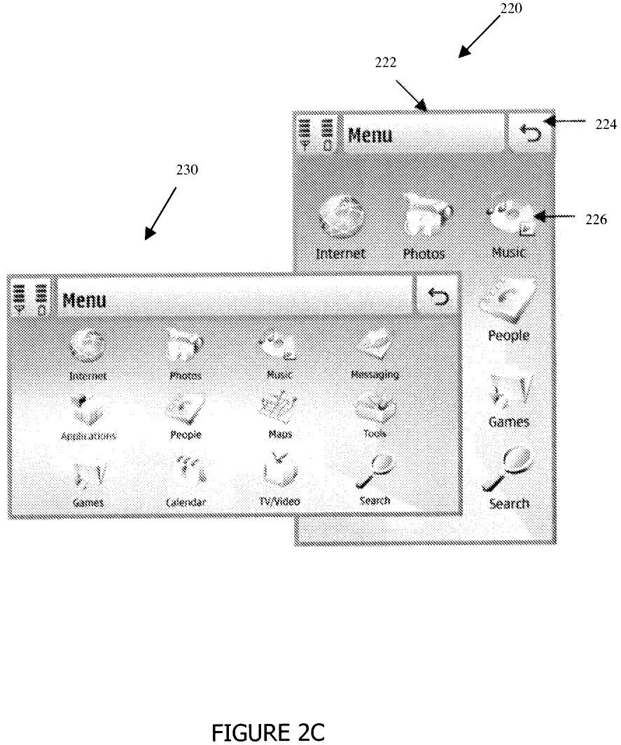

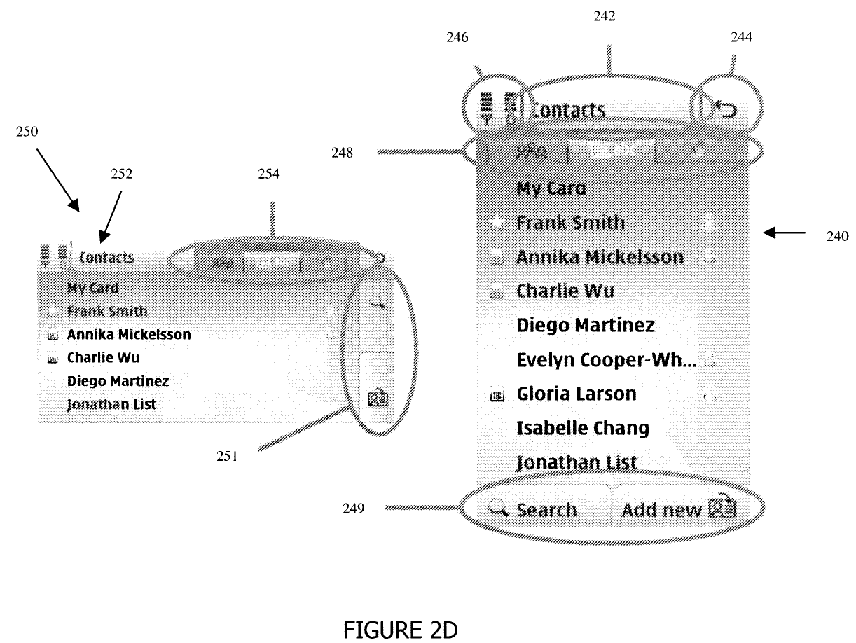

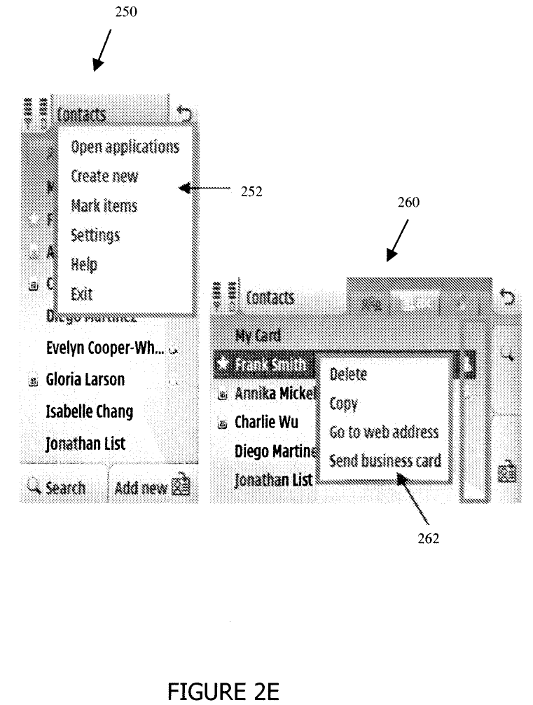

The aspects of the disclosed embodiments generally provide for associating one or more options that operate on the application with a title bar of an application screen view. More local items can be grouped and associated with specific items in an application view. Activation or selection of the title bar can open at least one option menu to present the one or more options that operate on the application, while selection or activation of a specific item can open an associated menu that presents more local options. In one embodiment, one type of activation or selection command can open an application or view specific options menu, while another type of activation or selection command can open an item or object specific options menu. Referring to FIG. 2C, one example of an application screen view 220 is illustrated. The screen view 220 of FIG. 2C presents a menu of available functions, programs, applications and/or services. As shown in FIG. 2C, a title bar 222 is provided that is indicative of the particular application view. FIG. 2A illustrates another example, where the screen view 200 is for a Contacts application, as indicated in the title bar 202. Activation of the title bar in each of these examples can generate one or more options menus. The aspects of the disclosed embodiments group and associate functions that operate on an application and any cooperating applications, as well as group local functions related to a selected item or object. Associating the title bar with at least one option menu provides an easy and intuitive way to locate functions associated with an application or objects particular to the view. The functions that operate on the application and a current view of an application can easily and quickly be identified.

FIG. 1 illustrates one example of a system 100 incorporating aspects of the disclosed embodiments. Generally, the system 100 includes a user interface 102, process modules 122, applications module 180, and storage devices 182. In alternate embodiments, the system 100 can include other suitable systems, devices and components that allow for associating option menus with a title bar and allows for easy and quick identification and selection of the option menus. The components described herein are merely exemplary and are not intended to encompass all components that can be included in the system 100. The system 100 can also include one or more processors or computer program products to execute the processes, methods, sequences, algorithms and instructions described herein.

In one embodiment, the process module 122 includes an option menu selection module 136, an application/view specific options module 138 and an item or object specific option module 140. In alternate embodiments, the process module 122 can include any suitable option modules. The option menu selection module 136 is generally configured to determine which selectable item is being selected, such as for example the title bar 202 of FIG. 2A or menu item from the list of menu items 208, based upon a corresponding option menu selection command. In one embodiment, option menu selection commands can include for example, a tap, a double tap, or a tap and hold on the item, such as the title bar 202. In alternate embodiments, any suitable selection command can be used. For example, in one embodiment different menus can be associated with the title bar 202 and directional movements on or across the title bar 202 can correspond to different command inputs. A slide to the right on the title bar 202 can open one menu, while a slide to the left can open another menu. In one embodiment, different portions of the title bar 202 can be used to activate different option menus. For example, a tap or other command, on one side of the title bar 202 can activate one menu, while a tap on the other side can activate another menu. In one embodiment, activation of a middle portion of the title bar can be configured to activate or open another menu. As another example, when a pointer or cursor of a mouse device is moved over the title bar, or other selectable item, a right click on the mouse can generate one menu, while a left click can generate another. When the mouse or other cursor device includes multiple function keys or buttons, the activation of a respective button can activate a corresponding menu. Similar activation commands can be used with respect to the other selectable items that are presented in the application view 200, such as the items in list 208.

Based upon the received command or activation, the options menu selection module 136 can activate the application/view specific options module 138 or the item/object specific options module 140. In one embodiment, a selection input on the title bar 202 will activate the application/view specific options module 138 while a selection input with respect to an item from the list 208, will activate the item/object specific options module 140. The application/view specific options module 138 is generally configured to create, group and generate an options menu that includes functions that operate on the application and any cooperating application. For example, in a Contacts application, these functions might include “open application”, “create new”, “mark items”, “settings”, “help” and “exit.” The application/view specific options module 138 will group the available functions from current context menus and present the corresponding menu upon selection.

The item/object specific options module 140 is generally configured to group functions that are related to a specific view or object and present the corresponding menu. For example, in a Contacts application, functions that correspond to a selected contact view or object, such as item from list 208, can include “Delete”, “Copy”, “Go to web address” or “Send business card”, to name a few. Upon detection of a corresponding command or selection input, to either an item 208 or the title bar 202, the item/object specific options module 140 will cause the corresponding options menu to be generated. For example, in one embodiment, a specific item from the list 208 can be highlighted, such as those shown in screen 200. Then, if a corresponding item/object specific options command is detected or received, the associated menu is generated. In one embodiment, the command can be to the specific menu item, such as item from the list 208. Alternatively, the command is to the title bar 202. In this example, the command input to the title bar 202 will be distinct from a command to activate the application/view specific options menu. In one embodiment, the item/object specific options module 140 can provide a temporary focus or other similar highlight or indication on the affected object.

FIG. 2A-2E illustrate screen shots of exemplary user interfaces incorporating aspects of the disclosed embodiments. As shown in FIG. 2A, a screen or pane view 200 for an application item includes the title bar 202, view specific menu items 208, and a back or exit selector 206. In alternate embodiments other elements can be included in the view 200. In this particular example, the screen view 200 is for a Contacts application and menu items 208 is a list of contacts. The view 200 also includes function or tool tabs for “Search” 210 and “Add new” 212. In alternate embodiments any suitable tool or application specific elements can be included in the view 200.

The options menu 204 shown in FIG. 2A, is opened by selection or activation of the title bar 202. In this example, the options menu 204 shown in FIG. 2A includes functions or tools that operate on or are associated with the application identified in the title bar 202. In one embodiment, the options menu 204 comprises a pop-up window or menu. In alternate embodiments, the options menu 204 can be presented in any suitable manner on a display of a device. It is a feature of the disclosed embodiments to quickly, easily and intuitively inform a user of functions that are available in the current view and allow selection of any one of the functions in a quick and straightforward manner.

Referring to FIG. 2A, to open or access the menu 204, the user activates or selects the title bar 202 in any suitable manner. This can include for example, a tap, a double tap or a tap and hold. The specific type of activation will correspond to a particular options menus. In alternate embodiments any suitable icon or object selection method can be used. The menu 204 that includes the available functions will be displayed. A selection can be made from any one of the functions presented in the menu 204.

In one embodiment, one or more menus can be associated with an application item, such as the title bar 202. For example, one menu could comprise functions associated with the application item while another menu could comprise data associated with the application item. In one embodiment, a first menu could include application and/or view specific options or functions, while the second menu can include item and/or object specific functions or data. FIG. 2A illustrates an example where the options menu 204 includes view specific options for the contacts application, such as “open application” or “add a new contact.” FIG. 2B illustrates an example of item or object specific options menu 216. Here, the menu 216 only includes options related to the selected contact 218, such as “Delete” or “Copy.” In alternate embodiments, any suitable number of menus and menu types can be associated with an application item. For example, different application items, options, functions, services or data can be grouped into different menus. Each menu can be presented upon a suitable activation. To access the different menus, different activation types can be used. For example, to access one menu, a single tap activation can be used. To access the other menu, a double tap activation or a tap and hold can be used. In another embodiment, a slide motion can be used to access a menu so that detection of a sliding motion in one direction opens one menu, while a slide motion in an opposite direction will open another menu. In an embodiment that includes more than two menus, the number of taps on the selection item can be used to determine which menu will be configured and opened.

FIG. 2C illustrates different orientations and layouts for a user interface incorporating aspects of the disclosed embodiments. Screen 220 is in a portrait configuration and includes title bar 222, back/exit control 224, and indicators 226. Screen 230 shows the similar pane in a landscape configuration.

In FIG. 2D, different configurations for an application specific view are shown. Screen 240 is configured in a portrait mode while screen 250 is in a landscape configuration. The screen 240 includes a title bar 242 with view specific options control, back/exit/done control 244, utility/universal indicators 246, navipane/tabs 248, and toolbar 249. In the embodiment shown in FIG. 2D, the navipane/tabs 248 includes certain optional view specific functions. The toolbar 249 includes a search and Add New tab. In alternate embodiments, any suitable functions and/or controls can be included as can be one or more toolbars. In screen 250, which is a landscape configuration of screen 240, adjustments are made so that the viewable items of the configuration in screen 240 can also be visible in screen 250. For example, the navipane/tools 248 are repositioned from the main pane area of screen 240 to occupy part 254 of the title bar area. In an embodiment where the application view does not include tabs for tools 248, the title pane 252 can be extended in the landscape mode and can include longer texts, or other tabs, for example. The toolbar 249 of screen 240 is resized and/or reconfigured and repositioned to a side edge 251 of screen 250. In alternate embodiments, the navigation elements, tabs, toolbars and other items can be repositioned and resized to adjust to the respective screen and layout configuration.

FIG. 2E illustrates additional alternate screen and view configuration embodiments. In screen 250, the application specific options menu 252 has been activated by selecting the title bar. The screen 250 is in a portrait mode configuration. In screen 260, an item specific options menu 262 has been activated by selection of the item “Frank Smith”. In accordance with the aspects of the disclosed embodiments, and as shown in FIG. 2E, the need for an active scroll bar has been eliminated.

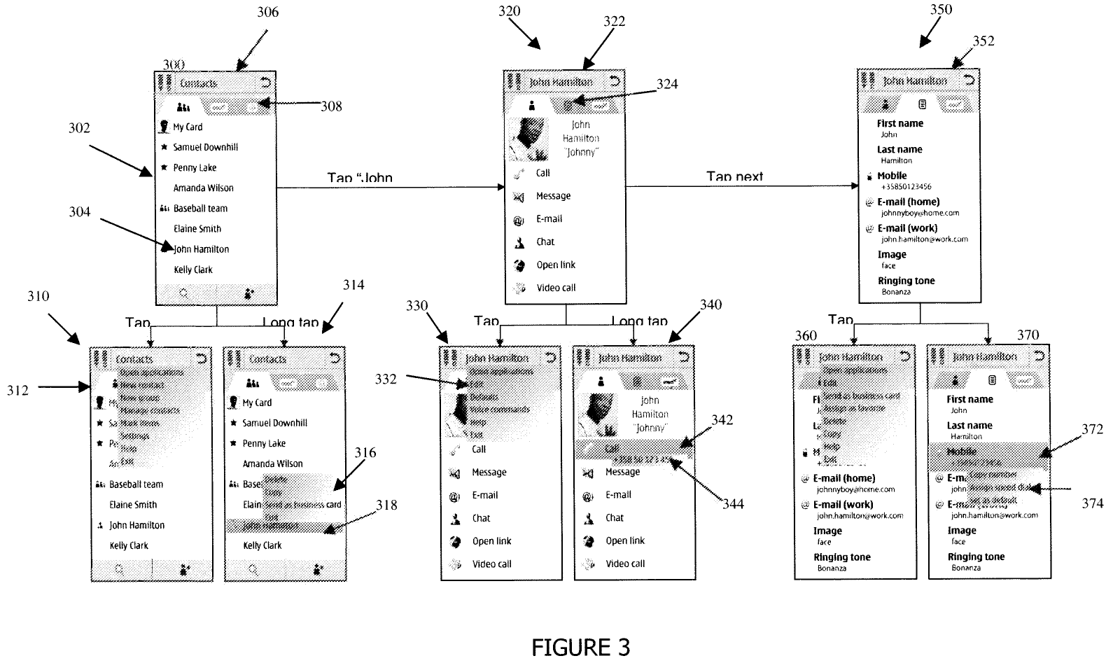

FIG. 3 illustrates one example of a process incorporating aspects of the disclosed embodiments. In this example, the screen view 300 includes a list 302 of contacts of a contact application. A single tap on the title bar 306 opens the application specific options menu 312 as shown in view 310. In one embodiment, a long tap on the title bar 306, after selecting item 304, opens the item specific options menu 316 in the view 314. In an alternate embodiment, the item 304 “John Hamilton” can be selected, and a long tap, or such other suitable activation command, on either the title bar 306 or the item 304, can be used to generate the item specific options menu 316.

Selection of the item 304 in FIG. 11, using for example a single or short tap, results in view 320, a more detailed view associated with the selection, which in this example includes the contact details for “John Hamilton.” In this view 320, a single tap on the title bar 322 opens the application specific options menu 332 in the view 330. These are options that are related to the application specific view 330. A long tap on the title bar 322, after selecting “Call” in view 320, opens the options menu 344, which in this example presents a phone number. As shown in view 340, the corresponding item 342 is highlighted. Alternatively, the item “Call” in view 320 can be selected with a long tap, for example, which will generate menu 344 and highlight the selected item 342.

Selection can also be made of the navipane/tabs 308. The view 350 corresponds to a selection of the tab 324 in view 320. The view 350 presents the contact details for the selected contact 304 “John Hamilton.” In this example, a “tap” on the title bar 352 opens the application/view specific options menu 362 shown in view 360. A “long tap” on the title bar 352, after selecting “Mobile” will open the item/object specific options menu 374 shown in view 370. As seen in view 370, the affected item/object 372 is highlighted. Alternatively, the item “Mobile” is selected, and the long tap on the selected item will open the corresponding menu, which in this example is menu 374. As each item in the screen 350 can include or be associated with different functions and options, different menus can be generated for each item, when selected.

In this example, it is demonstrated that each item that is selectable can have an alternative representation. As the user navigates through the different layers of an application, for example from the list of contacts 302 to a specific contact in screen 320, the associated application functions and item specific functions are regrouped. Further options are provided on a more local level and functions are grouped by their locality.

Referring to FIG. 1, the input device(s) 104 are generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112 and menu 124. The input devices 104 could also include a camera device (not shown) or other such other image capturing system. In alternate embodiments the input device can comprise any suitable device(s) or means that allows or provides for the input and capture of data, information and/or instructions to a device, as described herein.

The output device(s) 106 are configured to allow information and data to be presented to the user via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 can be used to receive and display information pertaining to content, objects and targets, as will be described below. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

In one embodiment, the applications module can also include a voice recognition system that includes a text-to-speech module that allows the user to receive and input voice commands, prompts and instructions, through a suitable audio input device.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, accessing and opening forms, and entering and viewing data in the forms in accordance with the disclosed embodiments. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications and state change requests. Depending on the inputs, the process module 122 interprets the commands and directs the process control 132 to execute the commands accordingly in conjunction with the other modules.

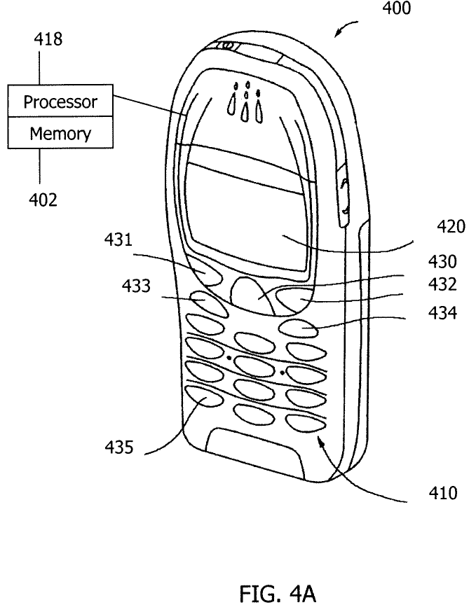

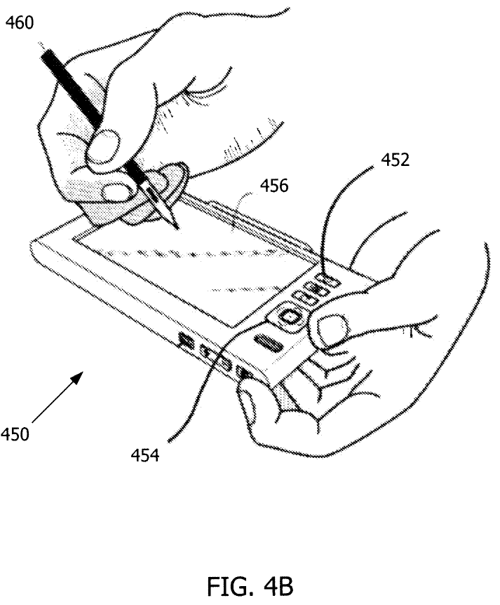

Referring to FIGS. 1 and 4B, in one embodiment, the user interface of the disclosed embodiments can be implemented on or in a device that includes a touch screen display, proximity screen device or other graphical user interface.

In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 may have a keypad 410 as an input device and a display 420 for an output device. The keypad 410 may include any suitable user input devices such as, for example, a multi-function/scroll key 430, soft keys 431, 432, a call key 433, an end call key 434 and alphanumeric keys 435. In one embodiment, the device 400 can include an image capture device such as a camera (not shown) as a further input device. The display 420 may be any suitable display, such as for example, a touch screen display or graphical user interface. The display may be integral to the device 400 or the display may be a peripheral display connected or coupled to the device 400. A pointing device, such as for example, a stylus, pen or simply the user's finger may be used in conjunction with the display 420 for cursor movement, menu selection and other input and commands. In alternate embodiments any suitable pointing or touch device, or other navigation control may be used. In other alternate embodiments, the display may be a conventional display. The device 400 may also include other suitable features such as, for example a loud speaker, tactile feedback devices or connectivity port. The mobile communications device may have a processor 418 connected or coupled to the display for processing user inputs and displaying information on the display 420. A memory 402 may be connected to the processor 418 for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as the processor 418 and memory 402 of FIG. 4A. In one embodiment, these devices will be Internet enabled and include GPS and map capabilities and functions.

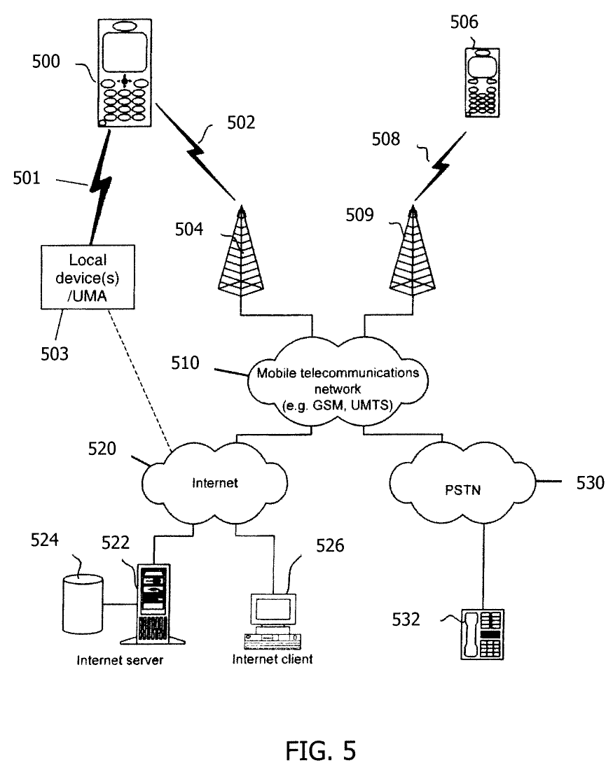

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communication module 134 that is configured to interact with, and communicate with, the system described with respect to FIG. 5.

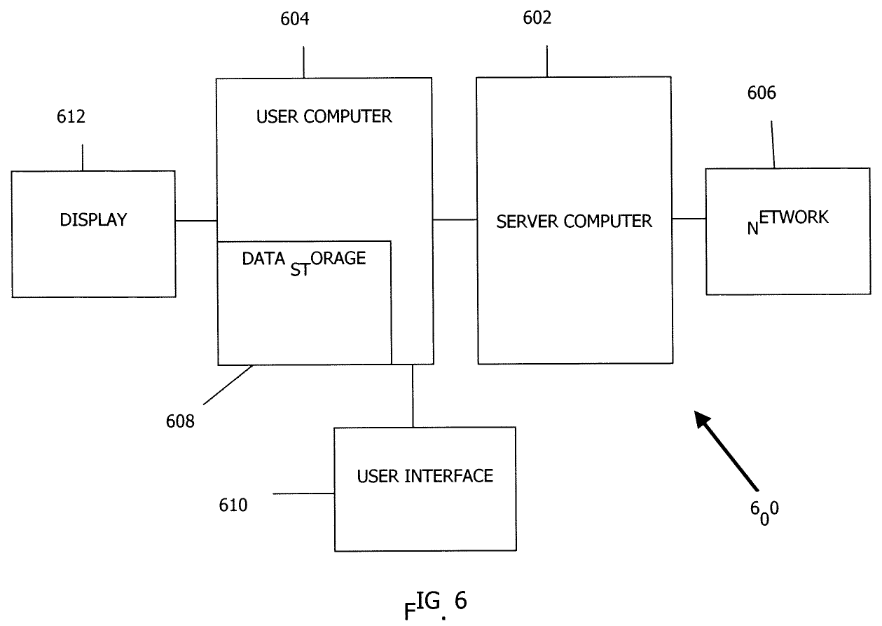

The disclosed embodiments may also include software and computer programs incorporating the process steps and instructions described above. In one embodiment, the programs incorporating the process steps described herein can be executed in one or more computers. FIG. 6 is a block diagram of one embodiment of a typical apparatus 600 incorporating features that may be used to practice aspects of the invention. The apparatus 600 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM” floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for associating one or more options that operate on the application with a title bar of an application screen view. More local items can be grouped and associated with specific items in an application view. Activation or selection of the title bar can open at least one option menu to present the one or more options that operate on the application, while selection or activation of a specific item can open an associated menu that presents more local options. Depending upon a selection or activation criteria, the different option menus can be presented to the user. Alternative views of each item can be provided, one being associated with data and another with functions. A more intuitive way of presenting a user with both data and the availability of associated functions allows the user to easily and quickly access the information without the need to navigate a menu hierarchy.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting an activation of a selectable item on an application view;
determining if the activation is one of a first type or a second type; and
if the activation is of the first type, presenting a menu of application specific options associated with an application view corresponding to the selected item; and
if the activation is of the second type, presenting a menu of item specific options associated with the selected item.

2. The method of claim 1 wherein each menu is presented as a pop-up window.

3. The method of claim 1 wherein the selectable item is a title bar or a tab of an application content screen.

4. The method of claim 1 wherein the activation of the first type is one of a tap, a long tap or a double tap, and the activation of the second type is different from the first type.

5. (canceled)

6. The method of claim 1 further comprising, after determining that the activation is of the first type, determining functions that operate on an application corresponding to the application view, grouping the functions, and providing the group as the menu of application specific options.

7. The method of claim 1, further comprising, after determining that the activation is of the second type, determining functions that operate on the application view of an application currently in use, grouping the functions, and providing the group as the menu of item specific options.

8. The method of claim 1, further comprising after presenting the menu of item specific options, highlighting a corresponding selected item.

9. The method of claim 1 further comprising that the selectable item is a title bar of the application view, wherein if the activation is a tap, the menu of application specific options is generated and if the activation is a long tap, the menu of item specific options is generated, the menu of item specific options corresponding to a highlighted selection item in the application view.

10. The method of claim 1 further comprising detecting that the selectable item is an item in the application view, detecting that the activation is a long tap, generating the menu of item specific options and highlighting the selected option.

11. An apparatus comprising:
a display; and
a processor configured to detect an activation of a selectable item on an application view on the display;
a processor configured to determine if the activation is one of a first type or a second type;
a processor configured to present a menu of application specific options associated with the application view if the activation is of the first type; and
a processor configured to present a menu of item specific options associated with a selected item in the application view if the activation is of the second type.

12. The apparatus of claim 11 further comprising that:
the processor configured to present a menu of application specific options associated with the application view is further configured to associate and group functions that operate on the application view prior to presenting the menu of application specific functions; and
the processor configured to present a menu of item specific options associated with a selected item in the application view is further configured to associate and group local functions corresponding to the selected item prior to presenting the menu of item specific options associated with the selected item.

13. The apparatus of claim 11 further comprising that the processor configured to detect an activation of a selectable item on an application view on the display is configured to determine if the selectable item is a title bar of the application view or an item in the application view, and if the selectable item is the title bar and the activation is of the first type generate the menu of application specific functions, and if the selectable item is an item in the application view and the activation is of the second type, generate the item specific options menu.

14. The apparatus of claim 11 further comprising that each menu is a pop-up menu presented on the display.

15. The apparatus of claim 11 wherein the apparatus comprises a mobile communication terminal.

16. The apparatus of claim 11 further comprising a processor configured interpret the application view, identify functions that operate on the application view and identify functions that operate on specific items in the application view, organize the functions into respective groups of functions, and present each group in response to the detection of a corresponding activation input.

17. A computer program product comprising computer readable code means stored in a memory, the computer readable code means configured to execute the method steps according to claim 1.

18. A user interface comprising:
at least a first selectable region in an application view, that when activated by a first input type, causes a menu of functions that operate on the application view to be generated and presented within the application view; and
at least a first selectable item in the application view, that when activated by a second input type, causes a menu of functions that operate on specific items to be generated and presented within the application view.

19. The user interface of claim 18 further comprising that the first selectable region is a title bar of the application view and the first selectable item is an object specific to the application view.

20. The user interface of claim 18 further comprising that each menu is presented directly from the application view.

21. The method of claim 1 further comprising selecting a contact from a list of contacts of a contacts application, and if the activation is of the first type, a contact application specific options menu is presented and if the activation is of a second type, a contact specific options menu is presented.
